(19) United States
(12) Patent Application Publication
(10) Pub. No.: US 2005/0175769 A1
(43) Pub. Date: Aug. 11, 2005

(54) Heat transfer method and heat exchange system between solid and fluid

(76) Inventors: Tomoaki Kunugi, Kyoto-shi (JP); Katsumi Muko, Kyoto-shi (JP); Souta Muko, Kyoto-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/101,542

(22) Filed: Apr. 8, 2005

Related U.S. Application Data
(63) Continuation of application No. PCT/JP02/13490, filed on Dec. 25, 2002.

(30) Foreign Application Priority Data
Oct. 10, 2002 (JP) 2002-297088

(51) Int. Cl. B05D 5/12

(52) U.S. Cl. 427/58

(57) ABSTRACT

Disclosed is a method of heat transfer between a solid such as a metal and a fluid such as water or air characterized in that a porous layer having numerous pores of a nano-size is formed on a surface of the solid that is in contact with the fluid, by treating the surface of the solid with a paste containing a particle group such as copper oxide (CuO), carbon (C) or alumina (Al₂O₃) having a diameter of 100 nm or less and an acid or an alkali. A completely novel method exhibiting an extremely high efficiency with a low cost is provided regarding the convective heat transfer among the heat transfer phenomena.

This is a continuation of an International application No. PCT/JP02/13490 having an International filing date of Dec. 25, 2002.

### TECHNICAL FIELD

This invention relates to a heat transfer method, and a heat exchange system or a heat exchanger between a solid and a fluid.

### BACKGROUND ART

The transport of thermal energy can be roughly classified into three transport phenomena of thermal radiation, heat conduction, and heat transfer. In the industrial application thereof, it is becoming a large subject not only for saving energy but also in a global environmental scale now to increase the thermal efficiency by use of sensible heat and latent heat transport through any medium or energy conversion and heat transmission into other media.

One object of this invention is to provide a completely novel method exhibiting extremely high efficiency with a low cost regarding the convective heat transfer (convective heat transfer) among the heat transfer phenomena. Another object is to provide a heat exchange system or exchanger of transferring heat between a solid such as a metal and a fluid such as water or air based on this novel method.

### SUMMARY OF THE INVENTION

In order to solve these objects, A suitable method for producing the heat exchange system or exchanger of this invention comprises a step of treating a surface of the solid that is in contact with the fluid with a group of particles having a diameter of 100 nm or less (hereafter referred to as “nano particles”) and being mixed with an acid or an alkali in an aqueous medium.

Conventionally, the heat transfer phenomena have been argued and summarized as empirical correlation formulas with Re (Reynolds number) representing the dynamic characteristics of fluid motion, Pr (Prandtl number) characterizing the thermal property of working fluid, Nu (Nusselt number) representing the heat transfer between working fluid and solid surface, Gr (Grashof number) representing the thermofluid characteristics when the working fluid is a buoyancy driving flow due to temperature or density difference. These correlations have been used to estimate the heat transfer coefficient of the proper thermal condition.

However, many of these empirical correlation formulas based on nondimensional numbers are derived by temperature and velocity distributions of the fluid based on boundary layer theory. According to this invention, the solid surface in contact with a fluid is treated with a nano particle group, whereby a porous layer having numerous nano-size pores is formed on the surface. As the result, a great improvement is achieved in the heat transfer mechanism within a laminar viscous sublayer, which has been dealt with only as molecular heat conduction in the fluid in conventional theories, and eventually the heat transfer coefficient increases.

In convective heat transfer, the method of this invention can be used for transferring heat from a high-temperature solid to a low-temperature fluid when a high-temperature heat source is on the solid side, and conversely can also be applied in transferring heat from a high-temperature fluid to a low-temperature solid when a high-temperature heat source is on the fluid side.

Therefore, the heat exchange system or heat exchanger according to this invention comprises a porous layer that contains numerous pores having a diameter of 100 nm or less is formed on the surface of the solid that is in contact with the fluid.

The aforesaid particle group may be copper oxide (CuO) carbon (C), alumina (Al₂O₃), or the like. Particles generally have a spherical shape; however, the particle shape is not limited to this alone, and may have a monolayer or multi-layer tube-shape in the case of carbon, for example, and the diameter may be smaller than about 100 nm in the case of carbon nano-tubes.

### BRIEF DESCRIPTION OF THE DRAWINGS

FIG. 1 shows a schematic view of an experimental apparatus for confirming the effect of this invention.

FIG. 2 shows the result of Example 1 in which the temperature is measured using the aforementioned apparatus.

FIG. 3 shows a relative evaluation of a heat transfer coefficient calculated from FIG. 2.

FIG. 4 shows the result of Example 2 in which the temperature is measured using the aforementioned apparatus.

FIG. 5 shows a relative evaluation of a heat transfer coefficient calculated from FIG. 4.

FIG. 6 shows the result of Comparative Example in which the temperature is measured using the aforementioned apparatus from which a heat transfer plate has been removed.

FIG. 7 shows a schematic view of another experimental apparatus for confirming the effect of this invention.

FIG. 8 shows the experimental result 1 of Example 3 in which the temperature is measured using the aforementioned apparatus.

FIG. 9 shows the water temperature change ratio of the experimental result 1.

FIG. 10 shows the experimental result 2 of Example 3 in which the temperature is measured using the aforementioned apparatus.

FIG. 11 shows the water temperature change ratio of the experimental result 2.

FIG. 12 shows a plane view of another experimental apparatus that confirms the effect of this invention.

FIG. 13 shows a front view of the same.

### DESCRIPTION OF THE PREFERRED EXAMPLES

### Example 1

[Experimental Apparatus]

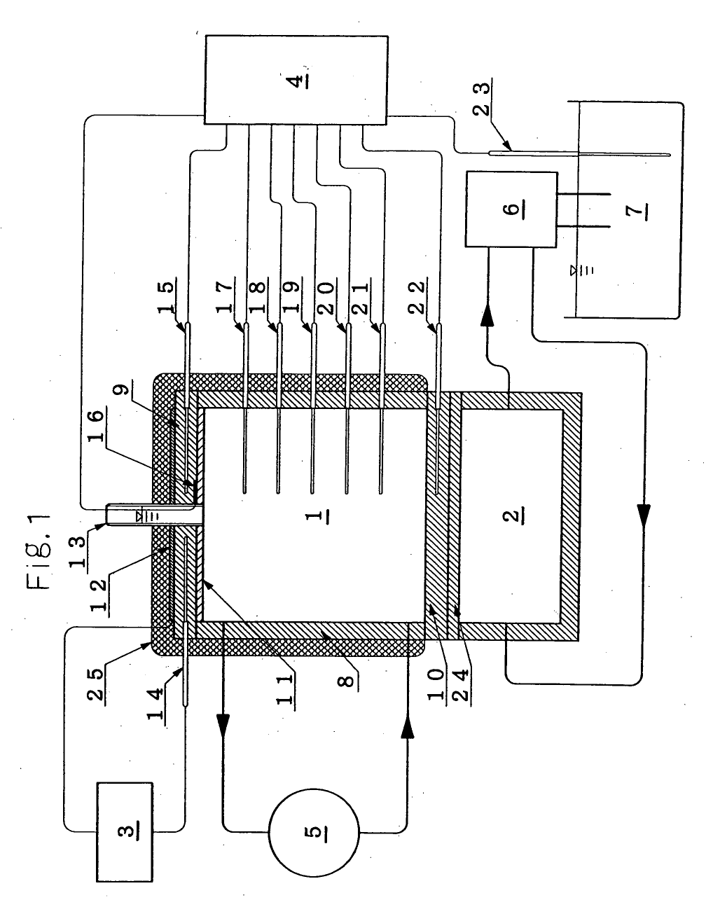

FIG. 1 shows a schematic view of an experimental apparatus for confirming the effect produced by the method of this invention. The experimental apparatus is mainly consisted of a cylindrical enclosure 1, a cooling chamber 2, a temperature controller 3, a temperature monitor 4, a circulation pump 5 for working fluid, a circulation pump 6 for coolant water, and a coolant water tank 7, and was placed in a room of 25° C.

The cylindrical enclosure 1 is consisted of a cylinder 8 made of hard vinyl chloride and having an inner diameter of 100 mm and a height of 100 mm, a lid plate 9 made of SUS304 fixed in a fluid-tight manner on the upper end surface thereof, and a bottom plate 10 made of SUS304 fixed in a fluid-tight manner on the lower end surface. The lid plate 9 and the bottom plate 10 are a disk shape having a thickness of 10 mm. A disk-shaped heat transfer plate 11 made of copper and having an outer diameter of 99.5 mm and a thickness of 1.5 mm is fixed to the lower surface of the lid plate 9 with a screw illustrated via silicone grease (model AK-100 manufactured by Taiwan Plowstar Co., Ltd.) not illustrated in the figure. Also, a panel heater 12 having an outer diameter of 100 mm and a heat capacity of 80 W is mounted to the upper surface of the lid plate 9 via silicone grease (same as above). The each thickness of silicone grease is about 0.05 mm, and the distance from the panel heater 12 to the heat transfer plate 11 is a heat conduction region (heat transport inside the solid). The lid plate 9, the heat transfer plate 11, and the panel heater 12 all have a through-hole having a diameter of 10 mm at the center, and a pipe 13 is inserted in a fluid-tight manner to serve both for air vent and for the amount of volume expansion, pressure relief at the time of volume expansion of the working fluid. The outer peripheral surface of the cylinder 8 and the upper surface of the panel heater 12 excluding the center are covered with a thermal insulating material 25.

Two temperature sensors 14, 15 made of a platinum resistor are inserted into the inside of the lid plate 9, where one temperature sensor 14 is connected to the temperature controller 3 to perform a PI automatic control of the lid plate 9 to a desired temperature, and the other temperature sensor 15 is connected to the temperature monitor 4 to be used for monitoring the temperature inside the lid plate 9. Here, a temperature sensor 16 made of a platinum resistor thin film and having a thickness of about 0.9 mm is installed into the boundary between the lid plate 9 and the heat transfer plate 11, and is connected to the temperature monitor 4 for monitoring the temperature of the upper surface of the heat transfer plate 11. Also, five temperature sensors 17 to 21 in total are inserted at an equal interval in the cylinder 8 in the vertical direction; another temperature sensor 22 is buried in the inside of the bottom plate 10; and another temperature sensor 23 is immersed in the water of the coolant water tank 7, all of which are connected to the temperature monitor 4.

On the other hand, the cooling chamber 2 is located under the cylindrical enclosure 1 to support it, and a base 24 made of SUS304 on the upper side is in close contact with the bottom plate 10. The inner diameter of the cooling chamber 2 is 100 mm, and the inside of the chamber is filled, at all times during the experiment, with cooling water having a temperature of 27.7° C. fed from the coolant water tank 7, and the cooling water is circulated by the coolant water circulation pump 6. Also, the cylindrical enclosure 1 is in a state of being filled with a tap water, where the tap water is circulated to be sucked in from the upper part and to be ejected from the lower part by the circulation pump 5 for working fluid.

In the experimental apparatus mentioned above, the panel heater 12 was controlled for adjusting the temperature of the lid plate 9 to be 50° C., whereby it was confirmed the temperature of each part to be in a steady state after 40 minutes.

Next, particles of copper oxide CuO (manufactured by United States Nanophase Technologies Co., Ltd., average particle size as determined by the measurement of SSA (specific surface area) based on the BET method=16 to 32 nm, approximately spherical) and nitric acid were mixed and prepared into a paste form, which was then applied all over the lower surface of the heat transfer plate 11, dried, and thereafter washed with water. A thin layer which was recognized to derive from the nano particles of copper oxide was formed on the lower surface to which the paste had been applied. When this layer was observed with a scanning electron microscope (hereafter referred to as SEM), the layer had numerous pores having a diameter of 100 nm or less.

[Experimental Procedure and Results]

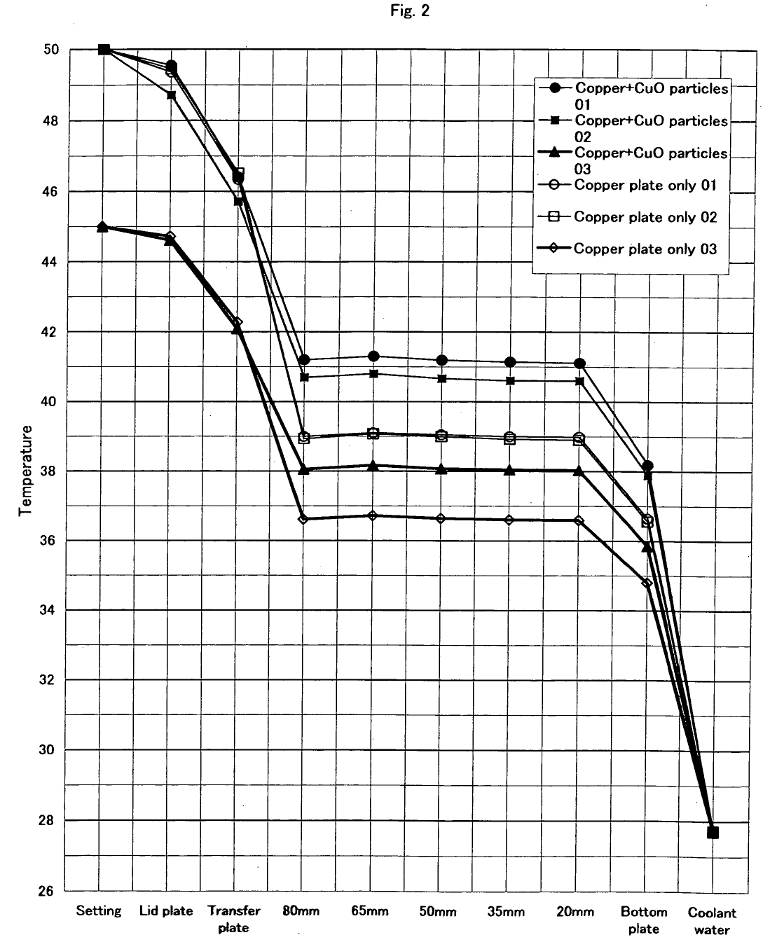

The heat transfer plate 11 on which the porous layer deriving from the copper oxide nano particles were formed was again incorporated into the above-described experimental apparatus; the panel heater 12 was turned on so that the temperature of the lid plate 9 would be 50° C. or 45° C.; the temperature of each part was measured every one minute after the start; and the experiment was ended when further 20 minutes passed after the steady state in which the temperature of each part became constant. Here, for comparison, the temperature had been measured under the same condition before the porous layer was formed on the heat transfer plate 11. The measurement result is shown in FIG. 2. Each temperature on the illustrated graph is an average value of the measured values of 20 times with the horizontal axis representing the positions of the temperature sensors, and the numerical values on the horizontal axis representing the distances from the bottom plate 10. In the figure, [copper plate+CuO particles 01] represents the data in the case where the specified temperature of the lid plate 9 was set to be 50° C. using the heat transfer plate 11 on which the porous layer deriving from the copper oxide nano particles had been formed, and [copper plate+CuO particles 02] represents the data obtained when the measurement was repeated under the same condition for confirming reproducibility. Further, [copper plate+CuO particles 03] represents the data in the case where the specified temperature was set to be 45° C. Furthermore, [copper plate only 01], [copper plate only 02], and [copper plate only 03] represent the data obtained by measurement under the same condition as described above except that nitric acid alone was used instead of the mixture of copper oxide nano particles and nitric acid.

First, since the data of [copper plate only 01] and [copper plate only 02] almost overlap with each other, it is recognized that the method of this invention has reproducibility. It is to be noted that the heat transfer from the heat transfer plate to the water at a position of [80 mm] to [20 mm] can be confirmed as a clear difference in the water temperature due to the presence or absence of nano particles. On the other hand, the heat transfer from the water in the lower layer [20 mm] in the cylindrical enclosure to the bottom plate can be assumed to be the same condition all throughout the experiment including the coolant water, so that the bottom plate naturally has a temperature corresponding to the water temperature.

[Heat Transfer Coefficient]

The above-described data are all based on the state in which the temperature of each part has become steady. Also, as will be understood from the data, the fluid temperature in the cylindrical enclosure indicates the average temperature of the upper surface temperature of the lid plate 9 and the lower surface temperature of the bottom plate 10, thereby demonstrating that there is no heat loss from the cylindrical enclosure and that, since the fluid region in the middle region of the cylindrical enclosure is isothermal, an adiabatic region is formed in the fluid region. Therefore, the heat flow that has passed through the upper surface of the cylindrical enclosure having a diameter of 100 mm undergoes convective heat transfer with the middle fluid region at the upper fluid region of the cylindrical enclosure, and is transported through the middle fluid region without heat loss, and undergoes convective heat transfer with the bottom plate at the lower fluid region. At this time, it can be said that the magnitude of the heat flow that passes through the upper and lower fluid regions is the same. By this experiment, it has been made clear that a heat transfer mechanism is present.

Assuming that the temperature of the heat transfer plate, the water temperature in the cylindrical enclosure, and the temperature of the bottom plate are respectively TC, TwM and TB, that the heat flux and the heat transfer coefficient from the heat transfer plate having an area of S to the water are qᵤₚₚₑᵣ and α_{CuTop}, and that those from the lower water region to the bottom plate are q_{lower} and α_{bottom}, the following equations hold for each.
qᵤₚₚₑᵣ*S=α_{CuTop}*(TC−TwM)*S
q_{lower}*S=α_{bottom}*(TwM−TB)*S

Since the heat f low is the same: qᵤₚₚₑᵣ*S=q_{lower}*S in the steady state as described above, the following equation holds.
α_{CuTop}/α_{bottom}=(TwM−TB)/(TC−TwM)

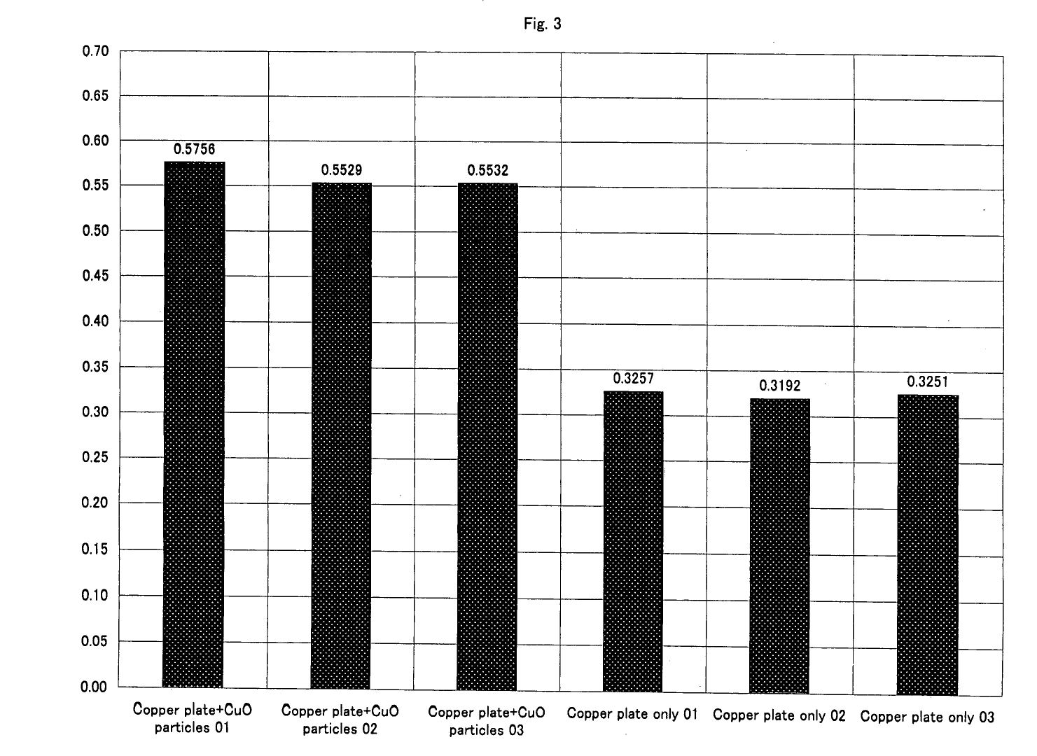

FIG. 3 illustrates this value of α_{CuTop}/α_{bottom} for each experiment case on the basis of FIG. 2. Under the condition such that the rotation number of the pump 5 is constant, the f low condition can be assumed to be the same, so that the heat transfer coefficient α_{bottom} from the lower water region to the bottom plate can be considered to be invariable. Therefore, the value of α_{CuTop}/α_{bottom}, as it is, can be considered to show the characteristics of α_{CuTop}, namely the index of the rate of relative increase of the heat transfer coefficient from the heat transfer plate of the upper water region.

From FIG. 3, it will be understood that, even if the specified temperature of the lid differs to be 50° C. and 45° C., there is no difference in the value of α_{CuTop}/α_{bottom}. It can be said that this, together with the fact that the data are recognized to have reproducibility, demonstrates the correctness of the conjecture on the above-described evaluation of the heat transfer coefficient.

Surprisingly enough, since the porous layer deriving from a slight amount of copper oxide CuO nano particles is formed on the heat transfer plate (copper plate) surface, the heat transfer coefficient from copper to water is improved by 60% or more compared with the characteristics of the heat transfer plate alone. Therefore, from the concept of heat transfer standing on the boundary layer theory of fluid, one cannot but think that the porous layer itself has a great influence on the temperature boundary layer. Also, it is surmised that the influence is not largely dependent on the metal as a parent body or the chemical species of the nano particles to be used.

### Example 2

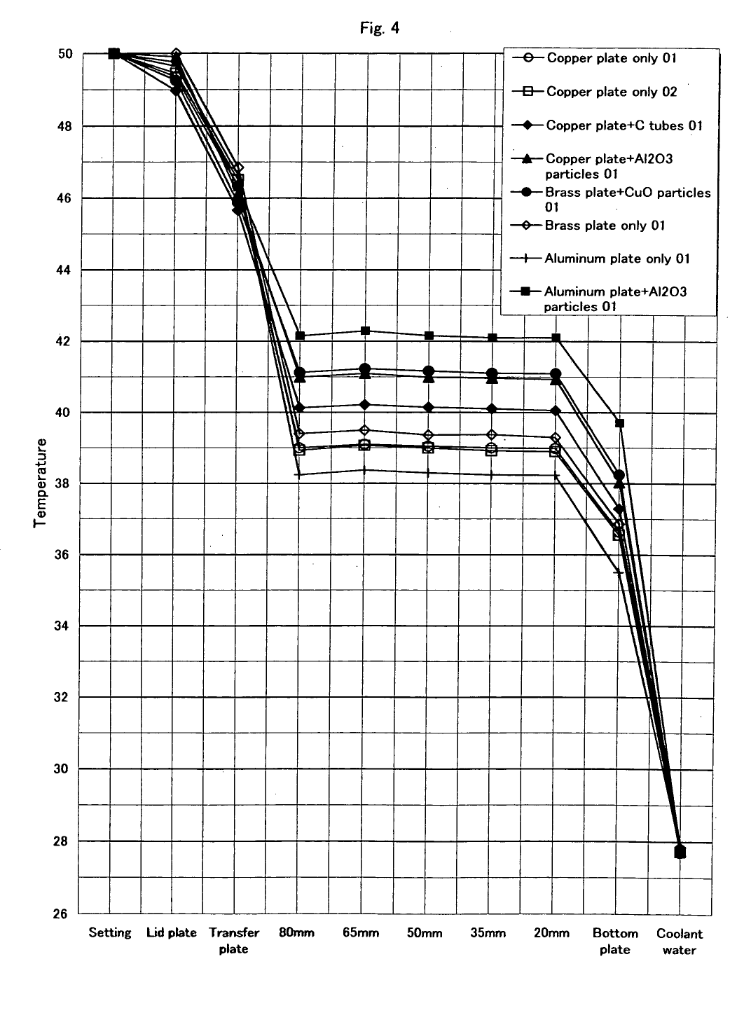

The temperature was measured under the same condition as in [copper plate+CuO particles 01] of Example 1 except that the heat transfer plate 11 was treated using carbon nano-tubes having a diameter of 20 to 30 nm and a length of 5 to 10 μm in place of the copper oxide nano particles. The temperature measurement results are shown in FIG. 4 as [copper plate+C tubes 01]. Here, when the surface of the heat transfer plate 11 was observed by SEM, it was found out that a layer with numerous pores having a diameter of 100 nm or less had been formed. Also, a slight amount of carbon nano-tubes maintaining the original shape were found to adhere thereon.

The temperature was measured under the same condition as in [copper plate+CuO particles 01] of Example 1 except that the heat transfer plate 11 was treated using aluminum oxide Al₂O₃ particles (manufactured by Nanophase Technologies Co., Ltd. in U.S.A., average particle size of 27 to 56 nm, approximately spherical) in place of the layer of copper oxide nano particles. The temperature measurement results are shown in FIG. 4 as [copper plate+Al₂O₃ particles 01]. Here, when the surface of the heat transfer plate 11 was observed by SEM, it was found out that a layer with numerous pores having a diameter of 100 nm or less had been formed.

The temperature was measured under the same condition as in [copper plate+CuO particles 01] or [copper plate only 01] of Example 1 except that the material of the heat transfer plate 11 was changed from copper to brass. The temperature measurement results are shown in FIG. 4 respectively as [brass plate+CuO particles 01] or [brass plate only 01].

The temperature was measured under the same condition as in [copper plate+CuO particles 01] or [copper plate only 01] of Example 1 except that the material of the heat transfer plate 11 was changed from copper to aluminum and that the aluminum oxide Al₂O₃ particles were treated with caustic soda aqueous solution. The temperature measurement results are shown in FIG. 4 respectively as [aluminum plate+Al₂O₃ particles 01] or [aluminum plate only 01] Here, [copper plate only 01] and [copper plate only 02] are a duplicated copy of the data of FIG. 3 for comparison.

As will be clear from the figure, the difference of experiment water temperature due to the presence or absence of the porous layer deriving from the nano particles can be confirmed irrespective of the material of the heat transfer plate and the chemical species of the nano particles to be used. The reason why the result of copper heat-transfer plate and carbon nano-tubes [copper plate+C tubes] showed a comparatively low water temperature seems to be that the carbon nano-tubes were less likely to form a porous layer on the heat transfer plate as compared with other nano particles. In any case, the reproducibility of the porous layer formation is confirmed, and no phenomena were seen such as the degradation of the formation degree or the deterioration of the heat transfer coefficient for every repetition of the experiment.

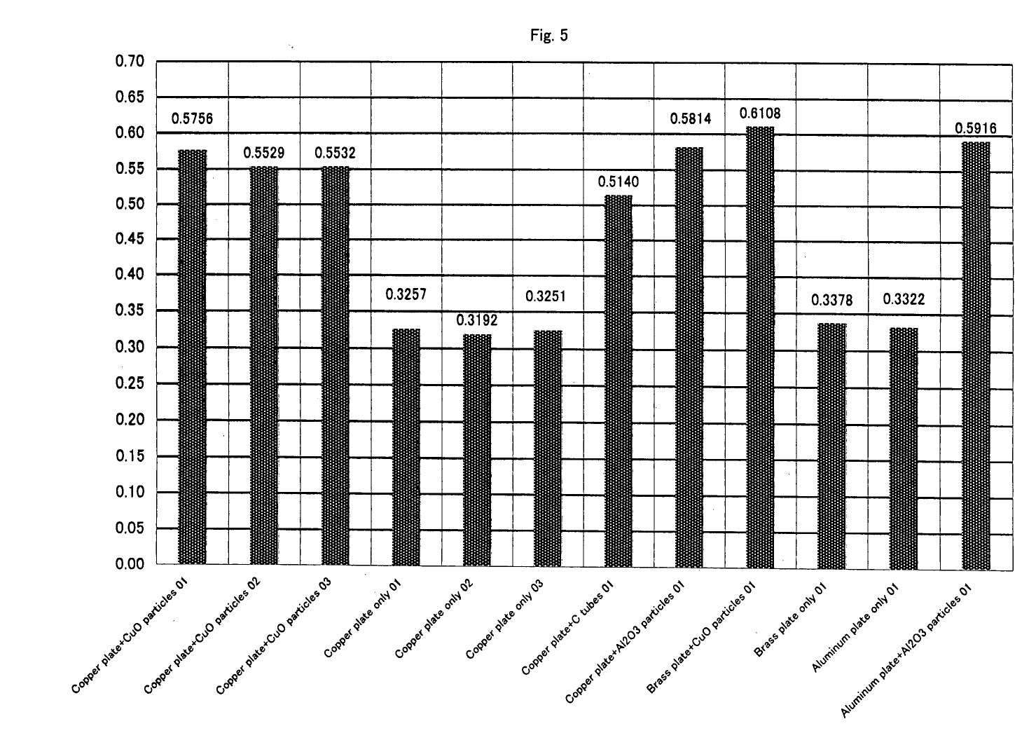

Next, FIG. 5 shows a result when the heat transfer coefficient was calculated using the same calculation formulas as in Example 1. As long as these series of data are concerned, a result was obtained such that the value of the combination of brass heat-transfer plate and copper oxide nano particles [brass plate+CuO particles] was the highest, namely, that the heat transfer coefficient was the best. The value shows a surprising improvement of 80% or more as compared with the heat transfer plate alone.

### Comparative Example

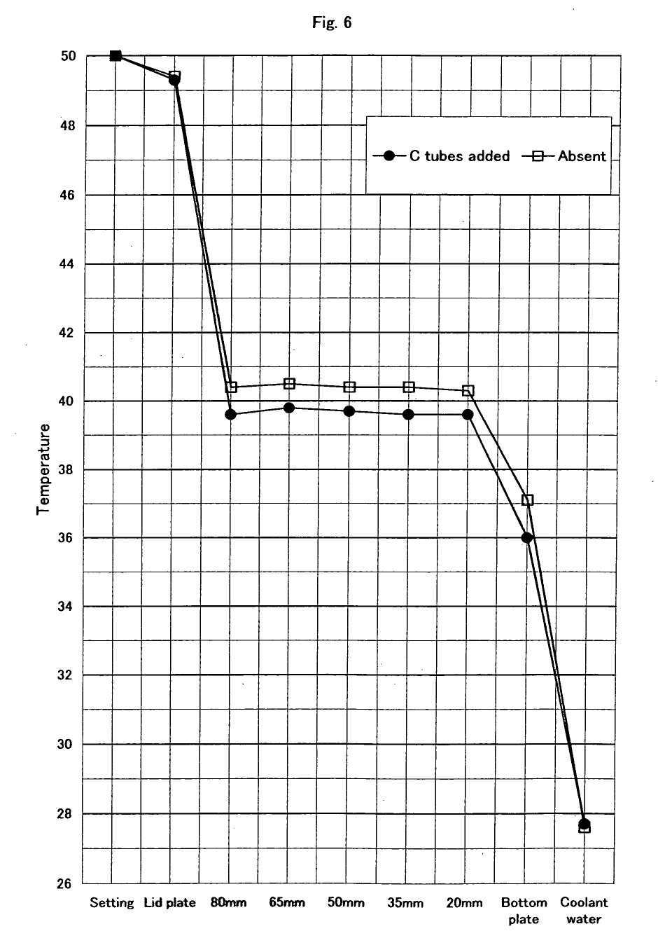

The heat transfer plate 11 and the temperature sensor 16 were removed from the experimental apparatus of Example 1. Then, the aforementioned carbon nano-tubes were added at a concentration of 0.01 g/L to the water in the cylindrical enclosure 1. Namely, a construction was made such that carbon nano-tubes containing water was in contact with the lower surface of the lid plate 9. The temperature was measured under the otherwise same conditions as in [copper plate+CuO particles 01] of Example 1. Also, as a control, the temperature was measured in the case where the carbon nano-tubes were not added to water. These temperature measurement results are sequentially shown in FIG. 6 respectively as [C tubes added] and [absent].

As will be understood from FIG. 6, rather the water temperature of [absent] is higher by about 0.6° C. than that of [C tubes added]. Incidentally, the carbon nano-tubes were insoluble in water and, when the experiment was finished, a phenomenon was observed such that the particles agglomerated to form a mass.

Regarding the value of α_{CuTop}/α_{bottom}, α_{CuTop}/α_{bottom}=0.3576 in the case of carbon nano-tube containing water was a little smaller than α_{CuTop}/α_{bottom}=0.3667 in the case of water alone. Therefore, it is recognized that the heat transfer coefficient rather decreases by addition of carbon nano-tubes.

### Example 3

[Experiment Apparatus]

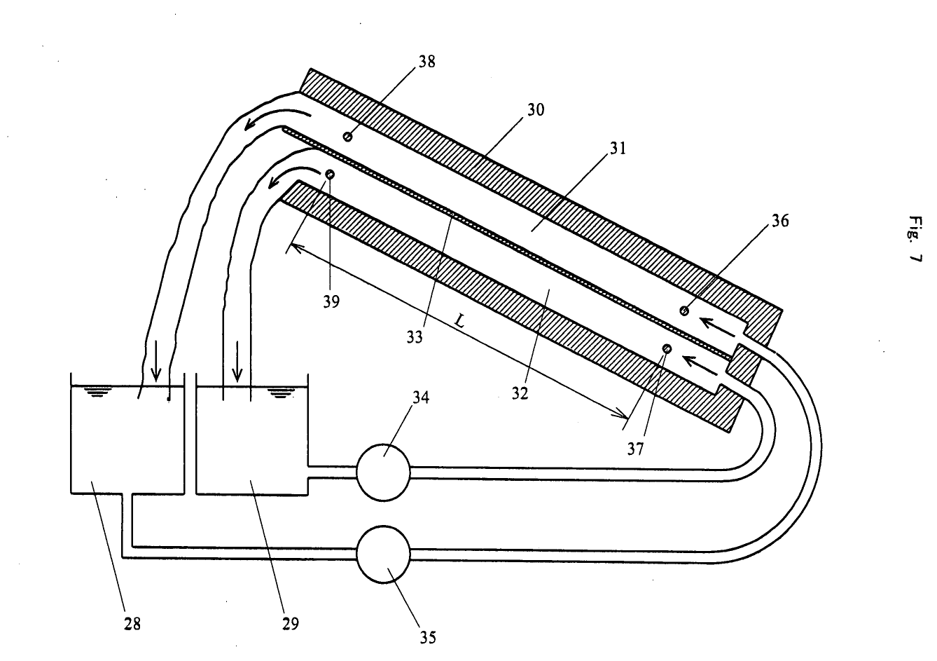

As illustrated in FIG. 7, a hot water tank 28 and a cold water tank 29 were prepared. Also, flow passages 31 and 32 consisting of two (upper and lower) channels were formed with a rectangular parallelopiped-shaped box 30 made of hard vinyl chloride resin having a thickness of 10 mm. The flow passages 31 and 32 have a cross section of a uniform size with a height of 15 mm×a width of 310 mm in the flow direction, and the upper flow passage 31 and the lower flow passage 32 are separated by a copper plate 33 having a thickness of 1.5 mm. The passages 31 and 32 have an inlet at one end of the flow direction and an outlet at the other end.

The box 30 was tilted so that the inlet would be down and the outlet would be up. Hot water was supplied to the inlet of upper flow passage 31, and cold water was supplied to the inlet of lower flow passage 32 (both of them were tap water) respectively by pumps 34 and 35. Then, the hot water and the cold water exiting from the outlets of the flow passages 31 and 32 flowed down respectively into the hot water tank 28 and the cold water tank 29, and regulation was made with a valve not illustrated so that the flow rates would be the same. Temperature sensors 36, 37, 38 and 39 were placed with a distance of L=1.8 m at the upstream (near the inlet) and at the downstream (near the outlet) of the flow passages 31 and 32, so as to perform automatic measurement of water temperature. After the inlet temperature of hot water and cold water was brought into a steady state, the measurement was made every 10 seconds for further 10 minutes, and each average value of the measurement values (number of data: 30) over at least 5 minutes or more from among these was regarded as a measurement result.

The heat transport from the hot water of the upper fluid region through the copper plate 33 to the cold water of the lower fluid region, whereby the temperature of the hot water that has flowed for 1.8 m decreases, and conversely the temperature of the cold water increases. The temperature difference of each is determined by the heat conduction due to the physical property of the copper plate 33 itself that partitions the fluid of the two upper and lower layers, the heat transfer from the hot water to the copper plate 33, and the heat transfer from the copper plate 33 to the cold water. Naturally, the higher the heat transfer coefficient is, the larger the temperature difference thereof will be.

The experiment was conducted under the four conditions of the case in which the copper plate 33 was treated with nitric acid alone [copper plate only], the case in which both surfaces of the copper plate 33 were treated with the same copper oxide nano particle containing paste as in Example 1 [both surfaces with nano particles], the case in which only one surface of the copper plate 33 on the hot water side was treated with the copper oxide nano particle-containing paste [hot surface with nano particles], and the converse case in which only one surface of the copper plate 33 on the cold water side was treated with the copper oxide nano particle-containing paste [cold surface with nano particles].

[Experimental Result 1]

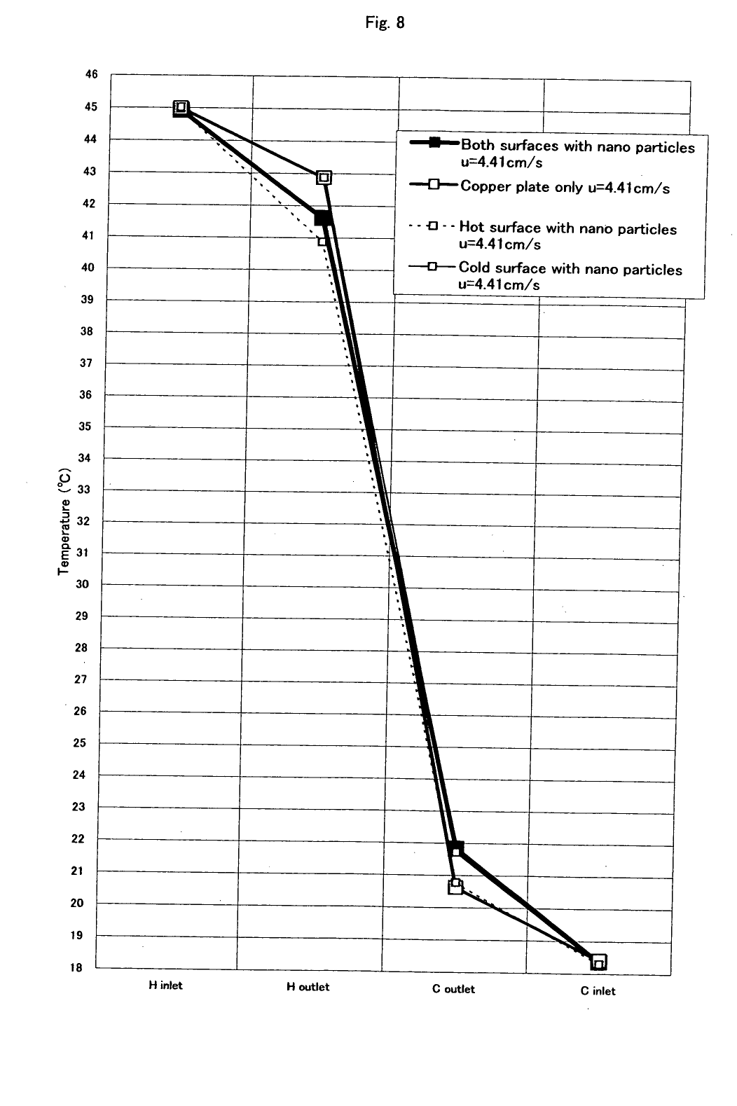

The experimental result in the case of the flow rate u=4.41 cm/sec is shown in FIG. 8. For all of the four conditions, the inlet temperature of hot water (Hinlet) and that of cold water (Cinlet) are almost under the same condition.

By comparison of [both surfaces with nano particles] and [copper plate only], there is a clear distinction in the temperature difference of the inlet and the outlet thereof for both hot water and cold water. Since the flow rates of the two flow passages and the heat transfer area (0.31 m×1.8 m) are the same, it can be considered that this distinction was generated by the difference of heat transfer coefficient from the hot water to the copper plate and from the copper plate to the cold water.

The result of [copper plate only] can be surmised from a conventional empirical correlation formula (formula of Churchill & Ozoe of laminar flow in a duct), and the calculated value and the experimental value were coincident at a considerable precision (the difference between the calculated value and the experiment value of the outlet temperature was 0.36° C.). In contrast, the experimental value of [both surfaces with nano particles] showed an improvement in that the heat transfer coefficients from hot water to copper and from copper to cold water were each 1.8 times as large as the calculated value.

The results of [hot surface with nano particles] and [cold surface with nano particles] respectively show that the heat transfer coefficient is improved in the cases in which a porous layer deriving from nano particles is formed.

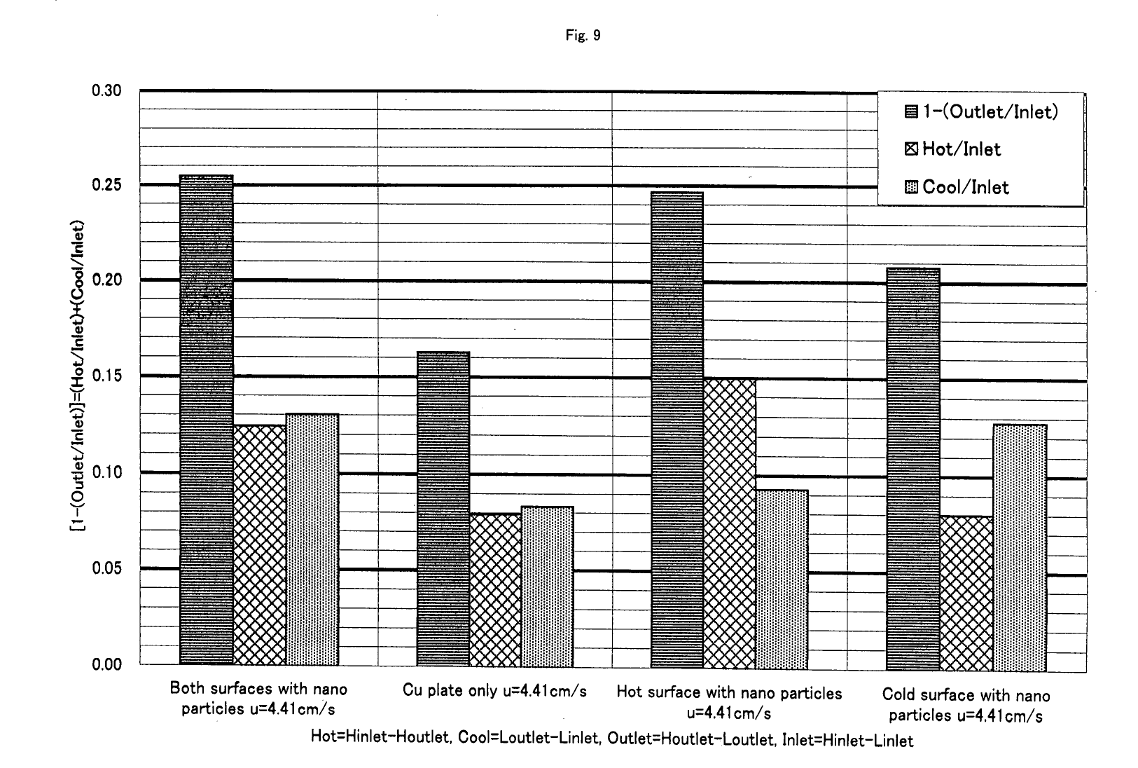

FIG. 9 shows the above results in a bar graph (water temperature change rate by heat exchange in case of U=4.4 cm/s). On the basis of the inlet temperature difference (Inlet) of hot water and cold water, the ratios of the temperature difference of hot water (Hot=Hᵢₙₗₑₜ−Hₒᵤₜₗₑₜ) and that of cold water (Cool=Cₒᵤₜₗₑₜ−Cᵢₙₗₑₜ) are shown as (Hot/Inlet) and (Cool/Inlet). The value of [1−(Outlet)/(Inlet)] is one in which the outlet temperature difference (Outlet) of hot water and cold water is incorporated, and the sum of (Hot/Inlet) and (Cool/Inlet) also shows the value of [1−(Outlet)/(Inlet)]. Conceptually speaking, the magnitude of the value of [1−(Outlet)/(Inlet)] represents the degree of improvement of heat exchange, i.e. heat transfer, and (Hot/Inlet) and (Cool/Inlet) suggest the degree of contribution of the respective ones.

The fact that the values of (Hot/Inlet) and (Cool/Inlet) are of the same degree in the cases of [both surfaces with nano particles] and [copper plate only] shows that the heat exchange in the case of ordinary parallel flow is stationarily established. Therefore, it seems that the theory of heat exchange can be applied, and the estimation calculation by the aforementioned empirical correlation formulas can be determined to be effective.

[Experiment Result 2]

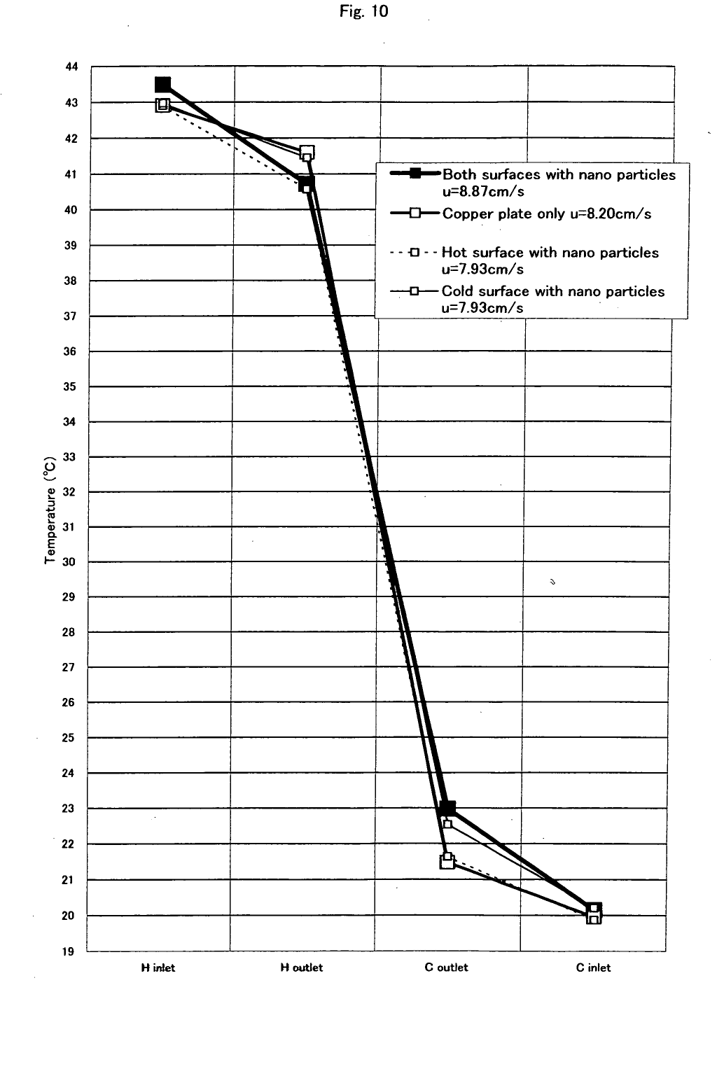

The experiment result in the case of the flow rate u=around 8 cm/sec is shown in FIG. 10. Since the flow rate is fast, it is difficult to control the inlet temperature of hot water (Hᵢₙₗₑₜ) and that of cold water (Cᵢₙₗₑₜ) of the four conditions, so that a little different condition applies.

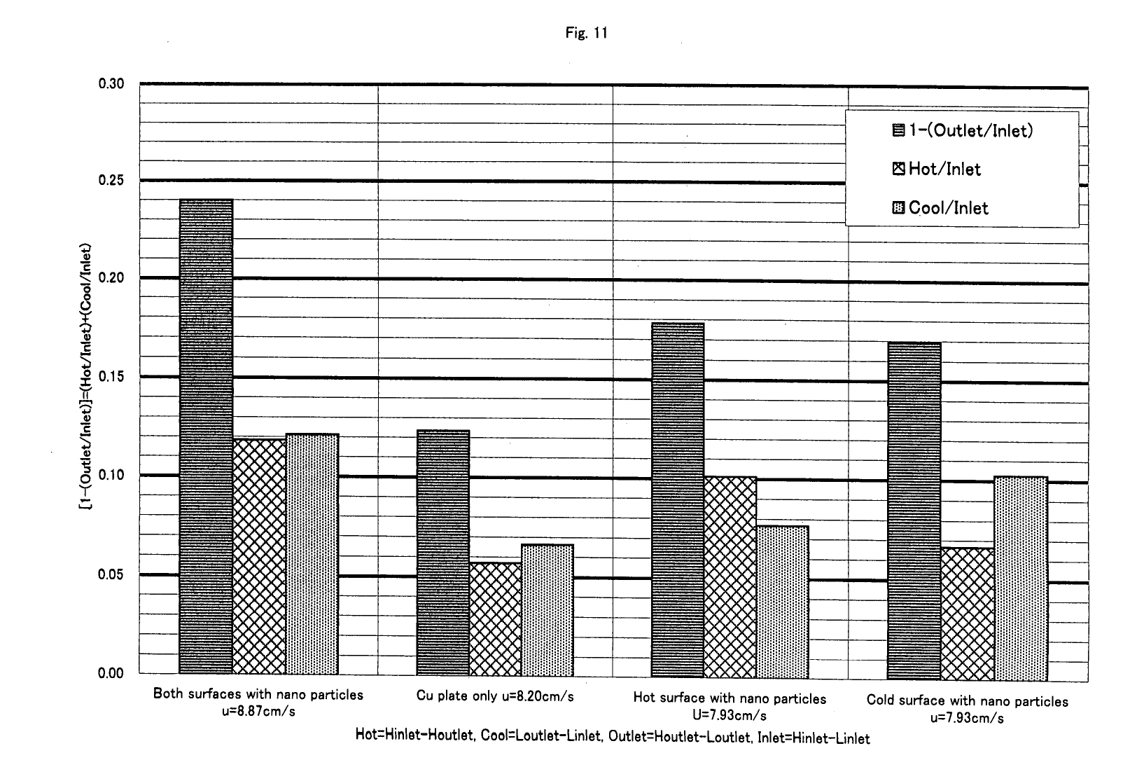

FIG. 11 shows the results in a bar graph (water temperature change rate by heat exchange, u=about 8 cm/s) in the same manner as the experimental result 1. The experimental results under each condition shows completely the same tendency as the result of the former case of flow rate u=4.41 cm/s. The experimental result and the calculated result in the case of [copper plate only] by the formula obtained by adding turbulent flow to the above empirical correlation formula (corrected formula of Petukhov of turbulent flow and formula of Churchill & Ozoe of laminar flow in a duct) were coincident at a good precision with a difference of 0.02° C. in the outlet temperature. In contrast, the experimental value of [both surfaces with nano particles] showed an improvement in that the heat transfer coefficients from hot water to copper and from copper to cold water were each 2.1 times as large as the calculated value.

FIG. 11 also briefly suggests the four kinds of experiment conditions. This is because [one surface with nano particles] is in the middle of [copper plate only] and [both surfaces with nano particles].

[On the Loss Accompanying the Flow of Fluid]

When one considers an ordinary general heat exchange system, there are many cases in which a fin or the like is considered, for example, for increasing the heat transfer area. However, they together have a negative element in that the energy loss accompanying the flow of fluid increases. Therefore, the increase in the frictional loss of the passage by the porous layer also is indispensable in evaluation of the system as a whole.

In this experiment, we intended to measure the frictional loss; however, by the calculation based on a conventional empirical correlation formulas (universal resistance law of a smooth tube: Prandtl•Karmann formula and an approximation formula of Colebrook considering the equivalent sand roughness), only the loss of about 0.9 mm water column is generated for the flow passage length of 1.5 m interval and, in fact, one could only make an eye observation by a manometer that the loss is less than or equal to 1.0 mm water column. Regarding the estimation of frictional loss due to the presence or absence of porous layer, an experiment with increased flow rate must be conducted. However, the surface with a porous layer formed thereon is a surface as if painted, and we note that a result has been obtained such that, by a calculation based on a Moody diagram introducing the equivalent sand roughness, only an increase of 3% or less is brought about in the friction coefficient even when compared with a smooth tube.

### Example 4

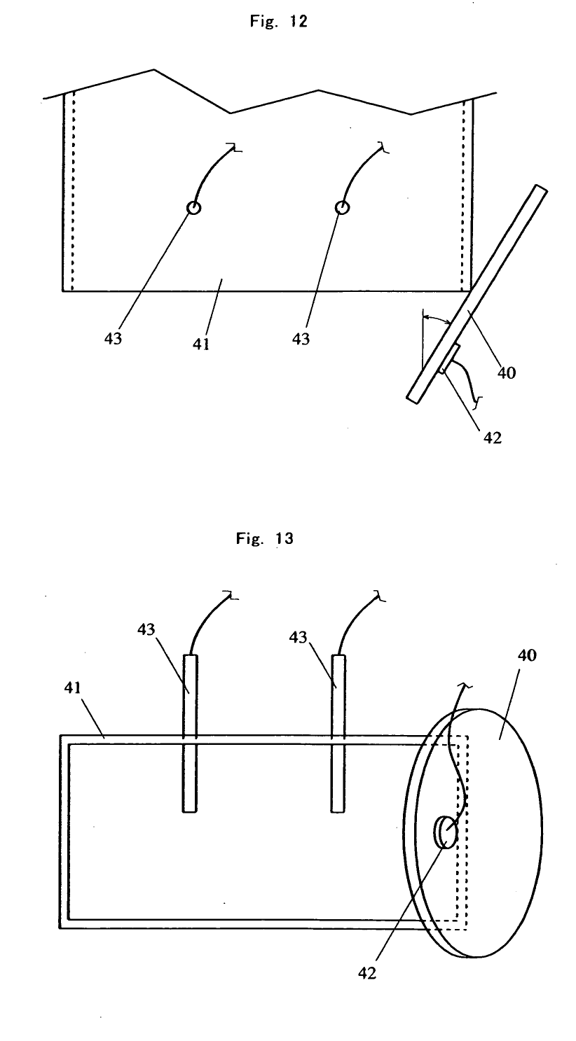

The Examples up to this are cases in which the fluid is water. In this example, the fluid is air. A test plate 40 obtained through the same steps as [copper plate+CuO particles 01] and [copper plate only] of Example 1 was fixed obliquely (angle of elevation α=30 degrees) at one end of the outlet of a blower duct 41 as illustrated in the plan view of FIG. 12 and in the front view of FIG. 13. Also, a temperature sensor 42 made of a platinum resistor thin film was attached to the back surface of the test plate 40, and a temperature sensor 43 was attached near the outlet of the blower duct 41. Then, hot air (117° C.) was blown at an air speed of 0.5 m/s to the test plate 40, and it was confirmed that the hot air does not go around to the back side of the test plate 40. The temperature of the test plate 40 that had reached into a steady state was measured by the temperature sensor 42. As a result of this, a clear distinction was recognized with the temperature of [copper plate only] being 57.5° C. and the temperature of [copper plate+CuO particles 01] being 59.2° C.

As described above, according to this invention, the heat transfer coefficient is considerably improved simply by treating the surface of a solid being in contact with a fluid as an object of heat transfer with nano particles or by forming a layer having numerous nano-size pores, so that this invention is useful in a heat exchange system such as an air conditioner or a hot water supplier or in every field that needs heat transfer.

1. A method of producing a heat exchange system for transferring heat between a solid that is in contact with a fluid and the fluid, the method comprising:
a step of treating a surface of the solid with a group of particles having a diameter of 100 nm or less and being mixed with an acid or an alkali in an aqueous medium.

2. The method of claim 1, wherein said solid is a metal.

3. The method of claim 1 or 2, wherein said group of particles is at least one selected from among copper oxide CuO, carbon C, and alumina Al₂O₃.

4. The method of claim 1 or 2, wherein said solid is a metal, and said group of particles is made of the same metal as the solid or an oxide thereof.

5. The method of any one of claims 1 to 4, wherein the fluid is water or air.

6. The method of claim 1, whereby the method comprises forming a porous layer that contains numerous pores having a diameter of 1100 nm or less on the surface.
